(19) United States
(12) Patent Application Publication
(10) Pub. No.: US 2004/0246878 A1
(43) Pub. Date: Dec. 9, 2004

(54) Optical disc drive

(75) Inventor: Seong-yeon Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/860,584

(22) Filed: Jun. 4, 2004

(30) Foreign Application Priority Data
Jun. 7, 2003 (KR) 2003-36605

(51) Int. Cl. G11B 5/09; G11B 7/00

(52) U.S. Cl. 369/124.03; 369/47.16; 369/47.36

(57) ABSTRACT

An optical disc drive with a structure that can reduce the access time to an optical disc required for information recording and reproducing. The optical disc drive includes a turntable on which an optical disc is rotatably loaded, and an optical pickup unit accessing a recording area of the optical disc to record or reproduce information, wherein the optical pickup unit includes at least two optical pickups that independently access different recording areas to simultaneously record information in or reproduce information from the different recording areas.

### CROSS-REFERENCE TO RELATED APPLICATIONS

This application claims the benefit of Korean Patent Application No. 2003-36605, filed on Jun. 7, 2003, in the Korean Intellectual Property Office, the disclosure of which is incorporated herein in its entirety by reference.

### BACKGROUND OF THE INVENTION

1. Field of the Invention

The present invention relates to an optical disc drive used to record information on an optical disc and reproduce information therefrom, and more particularly, to an optical disc drive having a structure that can reduce the access time to an optical disc required for information recording and reproducing.

2. Description of the Related Art

In general, optical disc drives are devices recording information in and/or reproducing information from an optical disc, which is a recording medium, by radiating light thereonto.

Referring to FIG. 1, a conventional optical disc drive includes a drive main body 10 and a tray 50 carrying an optical disc 1 into and out of the drive main body 10. A chassis 30, which is installed in the drive main body 10, includes a turntable 40 on which the optical disc 1 carried by the tray 50 is loaded and an optical pickup 20 recording information or reproducing information from the optical disc 1 while moving in a radial direction of the optical disc 1 loaded on the turntable 40. When the optical disc 1 is positioned on the turntable 40, the optical pickup 20 reproduces information recorded in a recording surface of the optical disc 1 or records information therein while the turntable 40 is rotated.

In a general optical disc drive having the above structure, only one optical pickup 20 accesses a target position on the recording surface while scanning the range from the inner circumference to the outer circumference of the optical disc 1, so that the access time is long. In particular, only sequential access is allowed even when there is a need to simultaneously read information from an inner region and an outer region of the optical disc 1, so that the distance by which the optical pickup 20 moves and the access time increase.

In large-capacity optical discs, such as game CDs becoming more popular in recent years and requiring high-speed processing, the access time is a significant quality factor affecting the ability to record and reproduce a large amount of information. Therefore, an optical disc drive which can reduce the access time is required.

### SUMMARY OF THE INVENTION

The present invention provides an optical disc drive with an improved structure that allows an optical pickup to access a optical disc within a short time for speedy, recording and reproducing operations.

According to an aspect of the present invention, there is provided an optical disc drive comprising: a turntable on which an optical disc is rotatably loaded; and an optical pickup unit accessing a recording area of the optical disc to record or reproduce information, wherein the optical pickup unit comprises at least two optical pickups that independently access different recording areas to simultaneously record information in or reproduce information from the different recording areas. The optical pickup unit may comprise: a first optical pickup accessing an inner recording area of the optical disc; and a second optical pickup accessing an outer recording area of the optical disc. The first optical pickup may access the inner recording area extending from the inner circumference to a circumference half way of the optical disc, and the second optical pickup may access the outer recording area extending from the circumference half way to the outer circumference of the optical disc. According to an aspect of the present invention, the optical pickup unit may comprise a first optical pickup accessing an inner recording area of the optical disc; a second optical pickup accessing an outer recording area of the optical disc; and a third optical pickup accessing an intermediate recording area of the optical disc. According to another aspect of the invention, method of recording and/or reproducing information for a disc drive comprising: accessing a first region of a disc to record and/or reproduce a first data onto and/or from a disc by a first pickup; and accessing a second region of the disc to record and/or reproduce a second data onto and/or from an optical disc by a second pickup. According to an aspect of the present invention, there is provided the disc drive comprising: a turntable on which an disc is rotatably loaded; and an pickup unit accessing a recording area of the disc to record and/or reproduce information, wherein the pickup unit comprises at least two pickups that independently access different recording areas to record information in and/or reproduce information from the different recording areas on a same side of the disc. According to an aspect of the present invention, a computer comprises optical pickup unit having a first optical pickup accessing an inner recording area of the optical disc; and a second optical pickup accessing an outer recording area of the optical disc.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional optical disc drive;

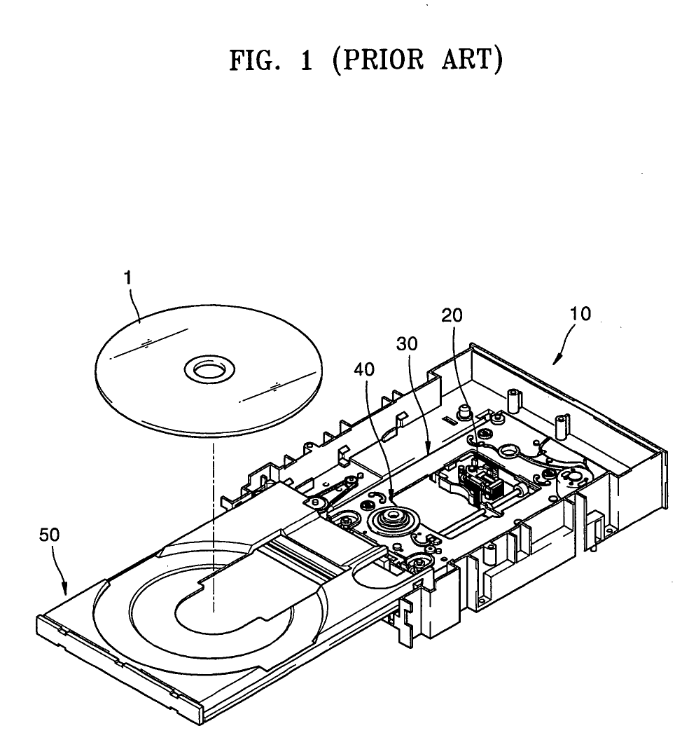

FIG. 2 is a perspective view of an optical disc drive including an optical pickup unit according to an embodiment of the present invention;

FIG. 3 is an enlarged view of the optical pickup unit of the optical disc drive shown in FIG. 2.

FIG. 4 is a view of the optical disc according to an embodiment of the present invention; and

FIG. 5 is a view of the optical disc divided into two regions according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

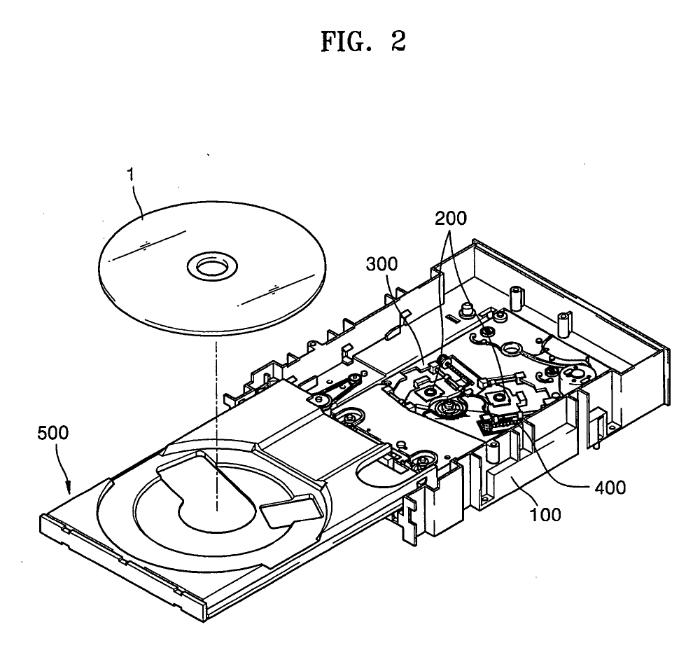

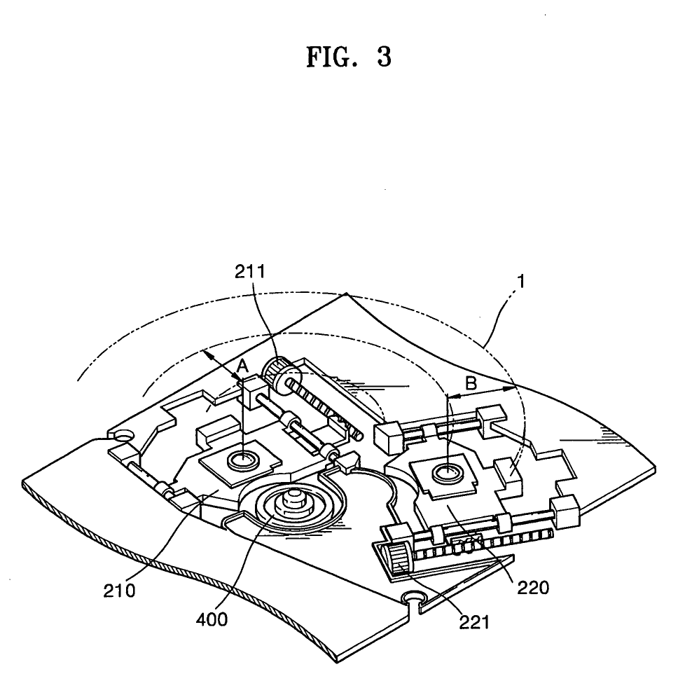

Referring to FIGS. 2 and 3, an optical disc drive according to an embodiment of the present invention includes a main body 100, a tray 500 coupled to the main body 100 such that an optical disc 1 can be carried into and out of the main body 100 thereby, a chassis 300 installed in the main body 100, a turntable 400 rotatably installed on chassis 300, and an optical pickup unit 200.

The turntable 400 receives the optical disc 1 carried into the main body 100 by the tray 500. The optical disc 1 on the turntable 400 is rotated while information is recorded or reproduced. The optical pickup unit 300 reciprocates in a radial direction of the optical disc 1 received on the turntable 400 and radiates light onto the optical disc 1 to record or reproduce information.

The optical pickup unit 200 includes a first optical pickup 210 that accesses an inner recording area A of the optical disc 1 and a second optical pickup 220 that accesses an outer recording area B of the optical disc 1.

In particular, the inner recording area A, which extends from the inner circumference to a circumference half way between the inner and outer circumferences of the optical disc 1, is accessed by the first optical pickup 210. The outer recording area B, which extends from the circumference half way to the outer circumference, is accessed by the second optical pickup 210. To this end, the first optical pickup 210 is driven by a first feeding motor 211, and the second optical pickup 220 is driven by a second feeding motor 221, which is operated independently from the first feeding motor 211. It is understandable that the length of A and the length of B can be the same length, the length of A is shorter than the length of B or the length of A is longer than the length of B.

In the optical disc drive having the above configuration, when recording information in or reproducing information from the optical disc 1, the first optical pickup 210 is driven by the first feeding motor 211 so that it accesses a position within the inner recording area A. The second optical pickup 220 is driven by the second feeding motor 221 so that it accesses a position within the outer recording area B. As a result, the access time can be reduced to half of the time required when only one optical pickup accesses the entire range from the inner circumference to the outer circumference of an optical disc as in a conventional optical disc drive.

The first and second optical pickups 210 and 220 are configured such that their information recording and reproduction signals can be fed back to the other optical pickup.

Although the optical pickup unit according to the present invention is described as including two or three optical pickups, i.e., the first and second optical pickups 210 and 220 or including the third optical pickup, in the above embodiment, the present invention is not limited to this structure and an optical pickup unit according to the present invention may include four or more optical pickups that access different recording areas.

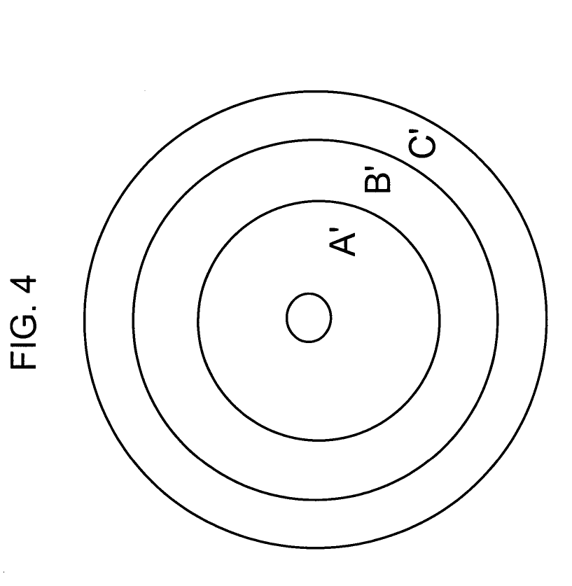

Referring to FIG. 4, according to another aspect of the present invention the first optical pickup 210 accesses an inner recording area A′ of the optical disc 1, the second optical pickup 220 accesses an outer recording area C′ of the optical disc 1 and a third optical pickup accesses an intermediate area B′.

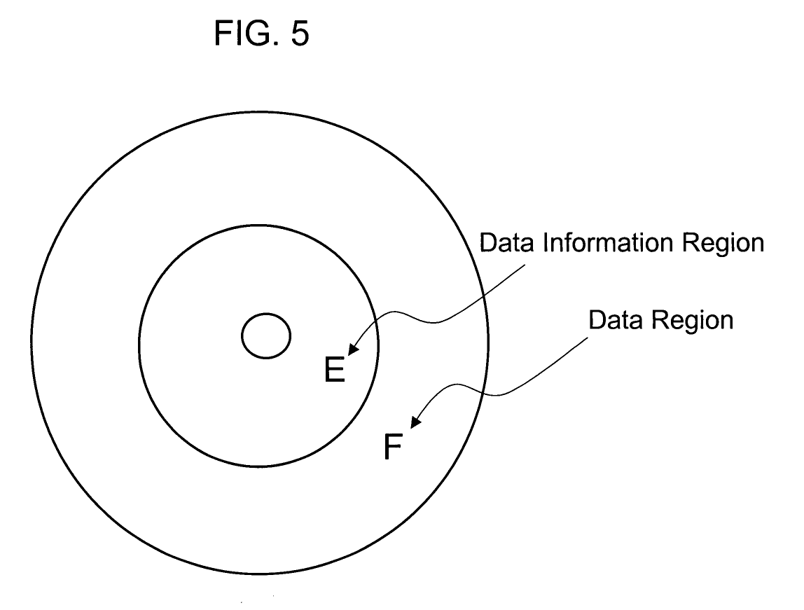

Referring to FIG. 5, according to another aspect of the present invention the optical disc recording area can be divided into two regions in accordance with data thereon, for example, an information data region can record information related data such as user's, disc related or manufacturer's data information and a data region which may record data such as audio or video data.

As is described above, an optical disc drive according to the present invention includes a plurality of optical pickups that access different recording areas divided along the circumference of an optical disc, so that the access time can be reduced, thereby enabling rapid information recording and reproducing operations. And also, it is understandable that a computer may comprises an optical disc drive including a turntable on which an optical disc is rotatably loaded; and an optical pickup unit accessing a recording area of the optical disc to record or reproduce information, wherein the optical pickup unit comprises at least two optical pickups that independently access different recording areas to simultaneously record information in or reproduce information from the different recording areas.

While the present invention has been particularly shown and described with reference to exemplary embodiments thereof, it will be understood by those of ordinary skill in the art that various changes in form and details may be made therein without departing from the spirit and scope of the present invention as defined by the following claims.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical disc drive comprising:
a turntable on which an optical disc is rotatably loaded; and
an optical pickup unit accessing recording areas of the optical disc to record or reproduce information,
wherein the optical pickup unit comprises at least two optical pickups that independently access different ones of the recording areas to simultaneously record information in or reproduce information from the different recording areas.

2. The optical disc drive of claim 1, further comprising different driving sources driving the at least two optical pickups.

3. The optical disc drive of claim 1, wherein the optical pickup unit comprises:
a first optical pickup accessing an inner recording area of the optical disc; and
a second optical pickup accessing an outer recording area of the optical disc.

4. The optical disc drive of claim 3, further comprising different driving sources driving the first optical pickup and the second optical pickup independently.

5. The optical disc drive of claim 3, wherein the first optical pickup accesses the inner recording area extending from the inner circumference to a circumference half way of the optical disc, and the second optical pickup accesses the outer recording area extending from the circumference half way to the outer circumference of the optical disc.

6. The optical disc drive of claim 3, wherein the first recording area of the disc comprises an information data region.

7. The optical disc drive of claim 3, wherein the second recording area of the disc comprises a data region.

8. A method of recording and/or reproducing information for a disc drive comprising: accessing a first region of a disc to record and/or reproduce a first data onto and/or from a disc by a first pickup; and
accessing a second region of the disc to record and/or reproduce second data onto and/or from the disc by a second pickup.

9. The method of claim 8, wherein the first pickup accesses relatively inner regions area of the disc than that of the second pickup.

10. The method of claim 8, wherein the first pick up recording a data onto the disc while the second pickup reproducing a second data from the disc.

11. The method of claim 8, wherein the first pickup accesses the inner recording area extending from the inner circumference to a circumference half way of the disc, and the second pickup accesses the outer recording area extending from the circumference half way to the outer circumference of the optical disc.

12. The method of claim 8, wherein the first recording area of the disc comprises a information data region.

13. The method of claim 8, wherein the second recording area of the disc comprises a data region.

14. A disc drive to access a disc, comprising:
a turntable on which the disc is rotatably loaded; and
a plurality of pickups respectively accessing different areas divided along a circumference of the disc.

15. The disc drive of claim 14, wherein the plurality of pickups simultaneously access the different areas.

16. The disc drive of claim 15, wherein the plurality of pickups are positioned at angles relative to each other with a rotation axis of the turntable being the center of the angles.

17. A computer having the optical disk drive of claim 1.
